(19) United States
(12) Patent Application Publication
(10) Pub. No.: US 2006/0160529 A1
(43) Pub. Date: Jul. 20, 2006

(54) Systems and methods for the automatic customization or configuration of mobile devices

(76) Inventor: Holger Glass, Bissingen/Teck (DE)

Correspondence Address: ROBERT M BAUER, ESQ.;LACKENBACH SIEGEL, LLP, 1 CHASE ROAD, SCARSDALE, NY, 10583, US

(21) Appl. No.: 11/035,473

(22) Filed: Jan. 14, 2005

(51) Int. Cl. H04M 3/00

(52) U.S. Cl. 455/418; 455/557

(57) ABSTRACT

Systems and methods for the automatic or streamlined customization or configuration of mobile devices are provided. In accordance with one embodiment of the present invention, a mobile device is provided with an installation agent that aids in installation of new device applications by fully or partially automating the installation process. Another aspect of the invention includes providing a mobile device with an error-handling agent that streamlines or automates the process of correcting device malfunctions. Other aspects of the invention are-concerned with providing simplified user interfaces for mobile devices and enabling the remote control and manipulation of a mobile device.

### BACKGROUND OF THE INVENTION

Mobile devices such wireless telephones, personal digital assistants (PDAs), and palmtop computing devices are common in modern society. Over time, these devices have evolved from relatively simple communications devices with a limited number of features to devices that include a wide range of sophisticated capabilities and functions. Wireless telephones, for example, which originally provided little more than mobile voice communications, now allow users to choose from a wide variety of enhanced features and customization options including mobile Internet, audio and video capabilities, as well as the use of other advanced applications such as gaming applications.

The evolution of these advanced services, however, has been accompanied by installation, customization and operation procedures of increasing complexity. For example, when a user initially purchases a wireless telephone or other mobile device, the setup procedure typically involves the user going through a somewhat complex and time consuming process of selecting certain operating options and customization preferences. In some instances, users are either unable or unwilling to take the time to properly or fully perform this process.

As a result, wireless users are often not taking full advantage of the feature set provided by a particular wireless device, which may lead to user dissatisfaction despite the fact the desired features may be actually present in the wireless device by following the proper the setup procedure. Furthermore, complicated customization and operation routines, including advanced user interfaces and a large number of options, act as an impediment to consumers purchasing additional customizations products such as gaming, audio and video products that generate additional revenue for service providers and wireless device manufacturers. Accordingly, in view of the foregoing, one desirable feature would be to provide systems and methods that that streamline or otherwise simplify the setup, operation and customization of a wireless device.

### SUMMARY OF THE INVENTION

Systems and methods for the automatic or streamlined customization or configuration of mobile devices such as wireless telephones are provided. In accordance with one embodiment of the present invention, a mobile device is provided with an installation agent that aids in installation of new device applications by fully or partially automating the installation process. Another aspect of the invention includes providing a mobile device with an error-handling agent that streamlines or automates the process of correcting device malfunctions. Other aspects of the invention are concerned with providing simplified user interfaces for mobile devices and enabling the remote control and manipulation of a mobile device.

### BRIEF DESCRIPTION OF THE DRAWINGS

The above and other objects and advantages of the present invention will be apparent upon consideration of the following detailed description, taken in conjunction with the accompanying drawings, in which like reference numbers refer to like parts throughout, and in which:

FIG. 1 is a general block diagram illustrating a mobile unit including an installation agent constructed in accordance with an embodiment the present invention.

FIG. 2 is a general block diagram illustrating a mobile unit including an error-handling agent constructed in accordance with an embodiment the present invention.

### DETAILED DESCRIPTION OF THE INVENTION

In accordance with one embodiment of the present invention, systems and methods are provided herein that streamline and simplify the setup, operation and customization procedures of a wireless device and facilitate the process associated with handling errors encountered during the installation of new content or applications.

In one embodiment, the invention may include the installation and use of “agent” or “facilitation” software (or firmware) modules that operate in conjunction with the wireless device that aid in the selection, acquisition, downloading, operation and installation of certain application or customization software modules as well as aid in the setup, error handling and customization process. Such agent software modules may broadly include an installation agent(s), an error handler agent(s), translator agent(s), and a remote control agent(s). However, it will be understood that this list is merely exemplary and that other or differently configured agents than those described herein may be used if desired.

The agent modules described herein may be any suitable software or firmware that is capable of performing the functions described herein. This may include software or firmware created for use in mobile devices such as Java platform software developed by Sun Microsystems of Sunnyvale Calif. Such software may include agent modules based in whole or in part on the Java 2 Platform Micro Edition (J2ME) or similar software. In such Java embodiments, the agent modules may include an embedded application such as an applet, a MIDlet (e.g., a Mobile Information Device Profile) or similar managed application.

Such agent modules may be managed by certain application specific management software (either internal, external, or distributed) that is cognizant of the need to respond to and prioritize various external events (such as incoming and outgoing communications, etc.).

One such agent module that may be implemented on a mobile device in accordance with an embodiment of the present invention is an installation agent. The installation agent may be resident or otherwise installed on a mobile device such as a wireless telephone and may function to facilitate or otherwise streamline the installation of application software or aid in the customization of that mobile device.

In operation, a user of the mobile device may to desire to install a particular application such as a gaming application. Traditionally, this would require the user to go through a series of somewhat complex installation screens that ask for user input about various aspects of the mobile device or the user's preference regarding particular options for that application. The installation agent of the present invention may relieve the user of this burden by automatically activating at the beginning of the installation process and automatically install the application or simplify the installation steps required to be performed by the user. The may sometimes be referred to as the “installation mode.”

For example, in one embodiment, the installation agent may capture the screen displayed on the user interface associated with software installation, determine the questions being asked by the device, and provide preprogrammed or default answers to some or all of the questions involved in the installation process. The installation agent may accomplish this by monitoring the event queue or other buffer and capture the output of the mobile device (e.g., the graphical output). The installation agent may automatically provide an electronic response to the mobile device that is responsive to the question asked and may be equivalent to keypad input or the selecting of an on screen menu option by the user (e.g., by writing to the event queue of the mobile device). In this way, the application may be completely installed without any (or with little) user interaction.

In other embodiments, however, the installation agent may answer only some of the questions posed by the installation process, allowing the user to be more involved in a certain aspects of the installation procedure (e.g., such as being allowed to specifically specify certain user preferences or options). In yet other embodiments, the user of the mobile device may be given the option of activating or deactivating the installation agent altogether on an “application by application” basis to allow, at the user's option, full involvement and control over the installation process. This option allows end users with a greater technical capacity to be in full control of the installation process if desired.

Another way in which the installation agent may simplify the installation process is by modifying or overriding the output screens associated with the installation of a particular application and providing in their place a simplified installation display (or an animation or graphic indicating the automatic installation process is underway). In the case of a simplified installation screen, the installation agent may supply only certain questions to the user through the simplified display while automatically answering others, or may reformulate certain questions into more basic versions and supply the general information to the mobile device based on responses to the reformulated questions.

The installation agent may include some or all the required navigation steps (e.g., the sequence of keypad selections) necessary to navigate through a given menu item (or items). Such navigation steps may include in their aggregate, all the responses or input necessary to initiate, complete and confirm the download of an application and may also include activation of that application (e.g., by manipulation of the device event queue). An example of an application installed and activated in accordance with some embodiments of the present invention include a video or audio clip that is downloaded, installed and played at a particular time, possibly as specified by the user.

Another example may involve the installation of a mobile device “theme” which may include complementary or related audio, video or other graphics selected as a customization option. Such a theme application may be downloaded and activated automatically in accordance with the methods described above.

A Java-based embodiment of the installation module may employ one or more customized MIDlets as an installation agent. In such embodiments, the installation MIDlets may capture the screen output and write appropriate commands to the mobile device event queue to initiate and complete a certain application installation process by providing the same or substantially the same event queue input as would normally be provided by a knowledgeable user through a keypad. Embodiments of the invention may include some or all of the navigation steps required to complete and confirm installation of the application. The installation steps may be performed on the mobile device display such that the device user can observe the installation process, which may act as a passive learning tool to educate the user about device operation.

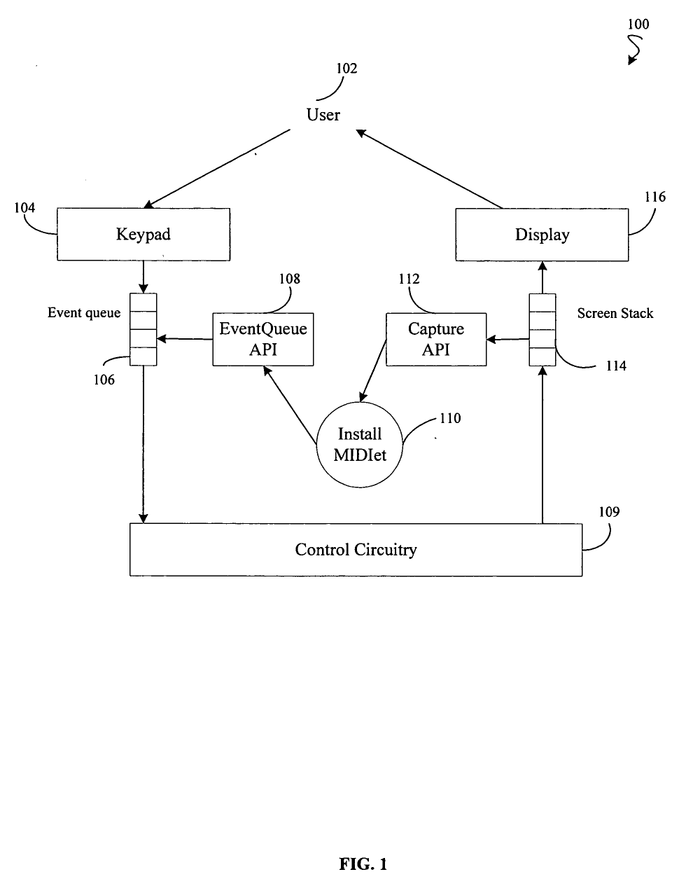

FIG. 1 illustrates a general block diagram of one possible mobile unit 100 constructed in accordance with the principles of the present invention including an installation agent 110 as described above. As shown, mobile unit 100 may include a keypad 104 (for use by user 102) and event queue 106, and event queue application interface (API) 108, control circuitry 109, an installation agent 110, a graphics capture API 112, screen stack 114 and a screen display 116.

In operation, installation agent 110 may automatically activate at the beginning of the application installation process and install the new software application. Control circuitry 109 and/or installation agent 110 may monitor the output of screen stack 114 (or other output buffer) to determine when an installation process begins. As shown, the installation agent may monitor screen 114 through a specialized capture API 112 designed for such a purpose. Control circuitry 109 may include or have access to a native or standard download procedure resident in mobile unit 100 that assists in the installation process.

Once the installation process has begun, installation agent 110 may capture the screen displayed on the user display 116 associated with software installation. Installation agent 110 may accomplish this by monitoring the event queue 106 (through API 108) and capturing the graphical output of the mobile device with capture API 112. Installation agent 110 may automatically provide an electronic response to the mobile device that is responsive to the information requested and write the response to the appropriate portion of event queue 108. This may be done such that it is substantially equivalent to keypad entry or the selecting of an on screen menu option by the user. In this way, the application may be completely installed without any (or with little) user interaction.

An additional agent module that may be implemented on a mobile device in accordance with an embodiment of the present invention includes an error-handling agent. The error-handling agent may be resident or otherwise installed on a mobile device and may be used to handle error situations by automatically correcting or aiding in the correction of certain malfunctions such as those associated with incorrect device configuration.

Such error-handling agents may be configured to recognize and automatically correct certain common problems encountered by users. For example, a mobile device may include an Internet browsing capability and/or support the transfer of various forms of multimedia content through email or other communications channels. Assume the device user desires to access the Internet via an installed browser, but no connectivity settings have been specified for the device. In prior art systems, the mobile device would simply display and error message indicating that “no active settings” were present and the user would likely have to consult the owner's manual to determine what this error message meant and how to correct the problem (e.g., by properly configuring the device through a series of time consuming and complex configuration commands).

The error-handling agent of the present invention, however, may be configured such that it recognizes certain error messages generated by the device and may perform certain appropriate predetermined steps in an effort to correct the error. For example, in operation, if the mobile device generates an error message, the device may report this message to the error-handling agent module to determine if the reported error is recognized by the error-handling agent. If the error is recognized, the agent may be invoked and take the appropriate remedial action. If not, an error message may be displayed on the device requiring the user to provide manual attention.

Assuming the error is recognized, the error-handling agent may employ one of several possible remedial actions. One type of remedial action may include performing a set of preprogrammed instructions designed to attempt to repair certain error conditions. The error handler may contain multiple specific error handling routines (e.g., MIDlets) each designed to fix specific malfunctions.

In the Internet browser example described above, the error-handling agent may take steps to automatically discover and configure the connectivity settings for mobile device. The connectivity settings may be configured to certain default values that provides the user basic Internet access based on system resources. These steps may be performed as described above by capturing screen displays and electronically simulating keypad input through an event queue to make certain configuration selections.

Another type of remedial action that may be employed by the error-handling module may include connecting the mobile device to a remote network operator or other systems specialist who may remotely configure the device to resolve the problem. This may occur with or without consultation with the device user. In some embodiments, the error-handling agent may first attempt to employ an automated repair as described above, and if unsuccessful, then may connect to a systems specialist. In addition, the error-handling module may be periodically updated to include new or improved automated error handling routines (e.g., over a wireless communications link such as wireless telephone network that includes a server for periodically updating this and the other modules disclosed herein).

In a Java-based embodiments, the error-handling module may employ one or more MIDlets that may use the PushRegistry of the J2ME platform or the JSR-211 Content Handler for recognizing certain native error events or certain problematic MIME (Multipurpose Internet Mail Extensions) types. If a native application of the mobile unit would generate and error message, that error message may be reported to an error-handling MIDlet, which, if it recognizes the error event, may then capture the screen display and either begin the automated error correction routine via event queue manipulation or connect to a system specialist for provisioning and configurations assistance.

The error-handling modules described above may also be used to track the error events generated by mobile units. For example, during the product development phase of a mobile unit, error handlers such as those described above may be used to report and log each error generated by the mobile unit. Such information may be useful in identifying system problems and to aid in system troubleshooting. This information may also be useful for deployed mobile units for similar reasons (allows system engineers to identify and fix commonly encountered problems, etc.)

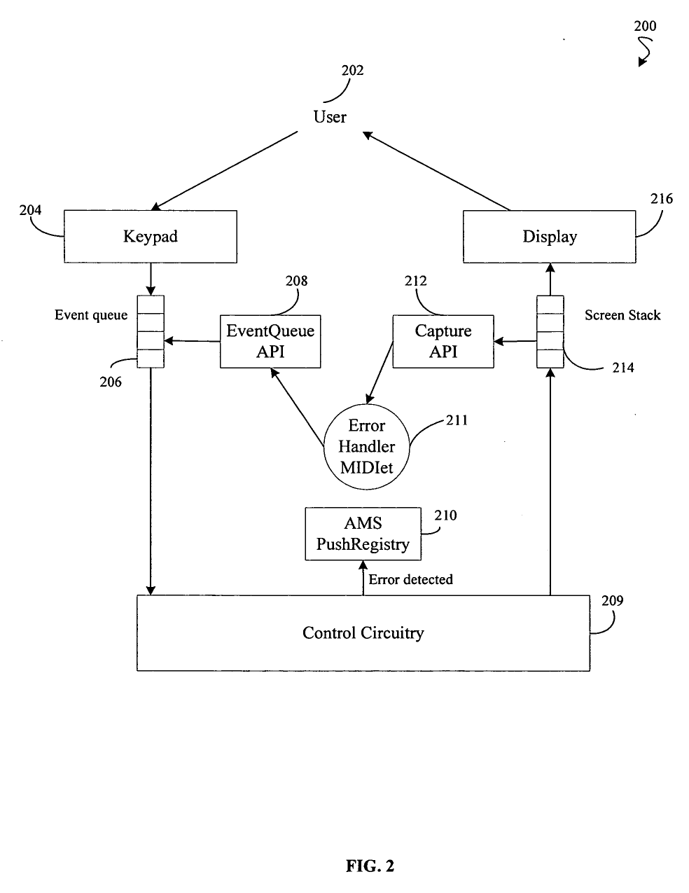

FIG. 2 illustrates a general block diagram of one possible mobile unit 200 constructed in accordance with the principles of the present invention including an error-handling agent 211 as described above. As shown, mobile unit 200 may include a keypad 204 (for use by user 202) an event queue 206, an event queue application interface (API) 208, control circuitry 209, an error recognition module 210, an error handler 211, a graphics capture API 212, and screen stack 214 and a screen display 216.

In operation, control circuitry 209 (which may include or have access to a native download procedure resident in mobile unit 100) may generate an error message indicative of a certain malfunction of mobile unit 200. This error message may be communicated to error recognition module 210, which, in certain embodiments may include MIDlets using the PushRegistry of the J2ME platform or the JSR-211 Content Handler. If the error message is recognized and a corresponding specific remedial error correction routine is located within error handler 210, the specific error routine may be loaded to event queue 206 through event queue API 208. Error handler 211 may monitor the output of screen stack 214 through capture API 212 to ensure that the specific error correction routine is responsive to the screen output and that the specific error correction routine is providing a beneficial function (e.g., the processes are in synchronization with one another).

If the error correction routine is not having the desired effect, error-handling agent 211 may terminate the automated error correction process and initiate contact with a remote operator for additional assistance. This may involve, for example, transmitting the contents of screen stack 214 to remote operator so that remote operator may see the same error messages as the user (discussed in more detail below).

Another type of agent module that may be implemented on a mobile device in accordance with an embodiment of the present invention may include a user interface translator agent (UI translator). The UI translator agent may be resident or otherwise installed on a mobile device and may be used to simplify complicated user interface menus by providing simplified versions of certain user interfaces that offer less features and are more straightforward to operate.

In operation, the UI translator agent may simplify otherwise complex user interfaces normally found on a sophisticated mobile device by replacing the complex user interface screen originally provided with the mobile device with a simplified screen generated by the UI translator agent. This simplified screen may be launched and configured from an applications menu that would allow a user to choose which features to retain on the resulting simplified interface. For example, a user may wish to have only call features present on the user interface (i.e., options relating to entering a telephone number to complete a call).

In this case, a user may select interface options on a “feature by feature” basis (or select from some predefined simplified interfaces) and create a simplified user interface that contains only the features desired by that particular user. After such a simplified interface is created, it may be stored within the mobile device and invoked and provided in place of the original, more complicated interface.

In a Java-based application, the UI translator agent may include one or more interface MIDlets that may suppress the original user interface and provide the simplified version selected/created by the user. In this embodiment, the mobile device event queue and output display may be fully or partially controlled by the UI translator MIDlet.

Another type agent module that may be implemented on a mobile device in accordance with an embodiment of the present invention includes a remote control agent. The remote control agent may be resident or otherwise installed on a mobile device and may be used by a network operator or system specialist to remotely control the mobile device for various reasons including helping a user to properly configure the mobile device, perform troubleshooting tasks, or help educate the user about system features or function.

In operation, a user may request assistance from remotely located assistance personnel by invoking an instance of the remote control agent. This may be accomplished by selecting a menu option on an applications menu which, in turn, may connect the mobile device to a “help desk” or other service personnel or automates service via the wireless communications link on the mobile device (in some embodiments, the mobile device may be connected automatically to a remote operator such as during system failure or an emergency situation).

In one embodiment, the remote service personnel may “proxy on” the user's mobile device and assume control of the device via the remote control agent. In such embodiments, the remote operator may have the same or similar screen views on his or her computer system as those produced by the mobile device along with the ability make menu selections and other take actions as if the remote operator were the mobile device user. In this way, the remote operator may remotely control the mobile device to assist the user in whatever device related tasks the user requires assistance with.

For example, after communication is established with a remote operator the via the remote control agent, the operator may remotely configure the mobile device to accomplish a specific task for the user or to correct a problem the user may be experiencing that he or she cannot otherwise fix.

Another application of the remote control agent may involve assistance with the initial setup of the mobile device. For example, when a user first purchases the device, many customization and other user options typically need to be selected. Rather than perform this cumbersome process alone, the user may invoke the remote control agent and merely describe the features or customization preferences desired to the remote operator who will configure the device accordingly for the user. This option eases the setup burden on the user and may aid in teaching the user about new features or illustrate easy and quick ways to customize the mobile device. This feature may encourage or enable users to purchase additional customization products that they otherwise would be unwilling or unable to do.

In a Java-based application, the remote control agent may include one or more control MIDlets that fully or partially control the mobile device event queue (with or without device display continuing to operate as it normally would). In such embodiments, the control MIDlet may initiate, monitor and coordinate communications with the remote operator. For example, the remote control MIDlet may initiate a GPRS or CDMA communication channel to the remote operator, monitor the communications and terminate the communications channel after the session is complete.

In such an embodiment, part of the MIDlet function may include capturing the current screen display and transmitting that display (along with any other pertinent device information) to the computer system of the remote operator. The control MIDlet may also coordinate communications and transfer incoming commands issued by the remote user and write them to the event queue of the mobile device. These commands may be queued by the mobile device and interpreted as commands issued from the device's keypad. In this way, the remote user can control the mobile device in effectively the same way as the device user.

It will be understood that although certain agent modules have been described above as separate entities that these modules may be combined to include some or all of the functions of the individual modules, applets or MIDlets described above. In addition, it will be understood that any given mobile device may include some or all of the functions described above whether installed or functioning separately or conjunctively, and such embodiments are within the scope of the present invention.

Moreover, in embodiments that contain MIDlets as a portion of a module may be governed by certain instantiation and life cycle constraints. For example, a MIDlet-based agent may operate in one of three possible states, paused, active or destroyed. A MIDlet's initial state may be the paused state in which the MIDlet awaits initialization or activation. While in the paused state the MIDlet may be considered inactive. When invoked by a management program the MIDlet may be initialized and change from the paused to active state in which the MIDlet can perform its intended function.

In some embodiments, if the MIDlet cannot be initialized it may immediately move to the destroyed state. A MIDlet may be deactivated by transitioning from the active state back to a paused state. A deactivated MIDlet may remain in the system as a process but typically will release as many resources (such as memory) as possible to allow other active processes to utilize those resources. Once a MIDlet is obsolete or outdated it may transition from active or paused to destroyed. In this case the MIDlet may receive a Boolean tag indicating this MIDlet is not to be used or may be deleted from program memory altogether.

Thus, it is seen from the above that systems and methods for the automatic customization of mobile devices are provided. It will be understood, however, that the foregoing is only illustrative of the principles of the invention and that various modifications can be made by those skilled in the art without departing from the scope and spirit of the invention. For example, although specific embodiments relating to the JAVA platform are specifically provided, any other suitable programming language, platform, or operating system may be used if desired. Accordingly, such embodiments will be recognized as within the scope of the present invention.

Persons skilled in the art will appreciate that the present invention can be practiced by other than the described embodiments, which are presented for purposes of illustration rather than of limitation and that the present invention is limited only by the claims that follow.

What is claimed is:

1. A system for automatically installing additional software applications on a mobile device comprising:
a queue for storing commands received from a keypad or external application;
an output buffer coupled to a display on the mobile device for receiving graphical output information; and
an install agent operatively coupled to the queue and output buffer, the install agent configured to monitor the content of the output buffer such that when the contents of the output buffer indicates a software application is being installed on the mobile device, capturing the install information from the output buffer and writing appropriate commands to the queue such that the desired application is automatically installed.

2. The system of claim 1 wherein the install agent includes a MIDlet.

3. The system of claim 1 wherein the output buffer includes a screen stack.

4. The system of claim 1 wherein the queue includes an event queue.

5. A system for handling errors generated in a mobile device comprising:
a queue for storing commands received from a keypad or external application;
an output buffer coupled to a display on the mobile device for receiving graphical output information;
control circuitry the coordinates the operation of the mobile device, the control circuitry configured to generate an error message when a mobile device malfunction occurs; and
an error handling agent operatively coupled to the queue, output buffer and control circuitry, the error handling agent configured to receive error messages from the control circuitry and determine whether the error message is recognized and to locate a specific error handling routine if the error message is recognized.

6. The system of claim 5 where the error handling agent is further configured to monitor the output buffer if a specific error handling routine is located and capture the error reporting information transferred to the output buffer and write the appropriate commands to the event queue responsive to the output buffer information such that encountered error is substantially automatically corrected.

7. The system of claim 5 wherein the error handling agent is configured to confirm that the specific error handling routine substantially corrected the malfunction indicated by the error message.

8. The system of claim 7 wherein the error handling agent is further configured to connect to an remote system operator if the specific error handling routine fails to substantially correct the malfunction indicated by the error message.

9. The system of claim 8 wherein the error handling agent includes a MIDlet.

10. The system of claim 9 wherein the MIDlets employ the PushRegistry of the J2ME platform or the JSR-211 Content Handler for recognizing an error message.

11. A system for customizing a user interface on a mobile device comprising:
a queue for storing commands received from a keypad or external application;
an output buffer coupled to a display on the mobile device for receiving graphical output information; and
an interface translator agent coupled to the queue and output buffer, the interface translator agent configured to receive commands from the queue and create a simplified user interface screen based on received commands and transmit the simplified interface to the output buffer thereby replacing an original interface screen with the simplified user interface screen such that the simplified user display screen is displayed when the mobile device is in use.

12. The system of claim 11 wherein the interface translator agent includes a MIDlet.

13. The system of claim 11 wherein the output buffer includes a screen stack.

14. The system of claim 11 wherein the queue includes an event queue.

15. A system for remotely controlling a mobile device comprising:
a queue for storing commands received from a keypad or an external application;
an output buffer coupled to a display on the mobile device for receiving graphical output information; and
a remote control agent coupled to the queue and output buffer, the remote control agent configured to coordinate communication with a remote operator and transmit the contents of the output buffer to the remote operator such that remote operator may observe the user interface displayed by the mobile device and receive communications from the remote operator and write commands received from the remote operator to the queue such that the remote operator has control over the mobile device.

16. The system of claim 15 wherein the remote control agent includes a MIDlet.

17. The system of claim 15 wherein the output buffer includes a screen stack.

18. The system of claim 15 wherein the queue includes an event queue.

19. A method for automatically installing additional software applications on a mobile device comprising:
storing commands on a queue received from a keypad or an external application;
receiving graphical output information in an output buffer coupled to a display on the mobile device; and
monitoring the content of the output buffer with an install agent such that when the contents of the output buffer indicates a software application is being installed on the mobile device, capturing the install information from the output buffer and writing appropriate commands to the queue such that the desired application is automatically installed.

20. The method of claim 19 wherein the install agent includes a MIDlet.

21. The method of claim 19 wherein the output buffer stores at least some graphical output information in a screen stack.

22. The method of claim 19 wherein the queue stores at least some commands in an event queue.

23. A method for handling errors generated in a mobile device comprising:
storing commands on a queue received from a keypad or an external application;
receiving graphical output information in an output buffer coupled to a display on the mobile device;
coordinating the operation of the mobile device with control circuitry, the control circuitry configured to generate an error message when a mobile device malfunction occurs; and
receiving an error message with an error handling agent, the error message being received from the control circuitry, the error handling agent determining whether the error message is recognized and locating a specific error handling routine if the error message is recognized.

24. The method of claim 23 wherein the error handling agent monitors the output buffer if a specific error handling routine is located and captures the error reporting information transferred to the output buffer and writes the appropriate commands to the event queue responsive to the output buffer information such that encountered error is substantially automatically corrected.

25. The method of claim 23 wherein the error handling agent confirms that the specific error handling routine substantially corrected the malfunction indicated by the error message.

26. The system of claim 25 wherein the error handling agent connects to a remote system operator if the specific error handling routine fails to substantially correct the malfunction indicated by the error message.

27. The system of claim 26 wherein the MIDlets employ the PushRegistry of the J2ME platform or the JSR-211 Content Handler for recognizing an error message.

28. A method for customizing a user interface on a mobile device comprising:
storing commands on a queue received from a keypad or an external application;
receiving graphical output information in an output buffer coupled to a display on the mobile device; and
receiving with an interface translator agent commands from the queue and creating a simplified user interface screen based on received commands and transmitting the simplified interface to the output buffer thereby replacing an original interface screen with the simplified user interface screen such that the simplified user display screen is displayed when the mobile device is in use.

29. The method of claim 28 wherein the output buffer stores at least some graphical output information in a screen stack.

30. The method of claim 28 wherein the queue stores at least some commands in an event queue.

31. A method for remotely controlling a mobile device comprising:
storing commands on a queue received from a keypad or an external application;
receiving graphical output information in an output buffer coupled to a display on the mobile device; and
coordinating communication with a remote operator and transmitting the contents of the output buffer to the remote operator through a remote control agent such that remote operator may observe the user interface displayed by the mobile device and receive communications from the remote operator and write commands received from the remote operator to the queue such that the remote operator has control over the mobile device.

32. The method of claim 31 wherein the remote control agent includes a MIDlet.

33. The method of claim 31 wherein the output buffer stores at least some graphical output information in a screen stack.

34. The method of claim 31 wherein the queue stores at least some commands in an event queue.

35. In a wireless communication system, a method for automatically installing additional software applications on a mobile device comprising:
storing a plurality of install agents on a remote server;
periodically updating an install agent stored on the mobile device with at least one of the install agent from the server; and
using the install agent to monitor the content of the an output buffer on the mobile device such that when the contents of the output buffer indicates a software application is being installed on the mobile device, capturing the install information from the output buffer and writing appropriate commands to the queue such that the desired application is automatically installed.

36. In a wireless communication system, a method for handling errors generated in a mobile device comprising:
storing a plurality of error handling agents on a remote server;
periodically updating an error handling agent stored on the mobile device with at least one of the error handling agents from the server; and
using the error handling agent to coordinate the operation of the mobile device with control circuitry, the control circuitry configured to generate an error message when a mobile device malfunction occurs; and
receiving an error message with an error handling agent, the error message being received from the control circuitry, the error handling agent determining whether the error message is recognized and locating a specific error handling routine if the error message is recognized.

37. A software program recorded on a tangible medium, the software program when executed on the mobile device causing the mobile device to monitor the content of an output buffer such that when the contents of the output buffer indicates a software application is being installed on the mobile device, capturing the install information from the output buffer and writing appropriate commands to the queue such that the desired application is automatically installed.

38. A software program recorded on a tangible medium, the software program when executed on the mobile device causing the software program to receive an error message generated by the mobile device and determine whether the error message is recognized and locating a specific error handling routine if the error message is recognized.

39. The software program of claim 38 wherein the software program monitors the output buffer if a specific error handling routine is located and captures the error reporting information transferred to the output buffer and writes the appropriate commands to a queue that are substantially responsive to the output buffer information such that encountered error is substantially automatically corrected.

40. A software program for customizing a user interface on a mobile device, the software program, when executed, creating a simplified user interface screen based on received commands and transmitting the simplified interface to an output buffer on the mobile device thereby replacing an original interface screen with the simplified user interface screen such that the simplified user display screen is displayed when the mobile device is in use.

41. A software program for remotely controlling a mobile device, the software program, when executed, coordinating communications with a remote operator and transmitting the contents of an output buffer of the mobile device to the remote operator such that the remote operator may observe the user interface displayed by the mobile device and write commands to a command queue received from the remote operator such that the remote operator has control over the mobile device.
